(19) United States
(12) Patent Application Publication
(10) Pub. No.: US 2007/0276679 A1
(43) Pub. Date: Nov. 29, 2007

(54) Hazard identification and tracking system

(75) Inventors: James Glen Gregoire, Orlando, FL (US); John M. Vogel, Palm Bay, FL (US)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(73) Assignee: Northrop Grumman Corporation, Los Angeles, CA (US)

(21) Appl. No.: 11/440,671

(22) Filed: May 25, 2006

(51) Int. Cl. G06Q 10/00; G06Q 30/00

(52) U.S. Cl. 705/1

(57) ABSTRACT

An apparatus comprises an input component for entering risk hazard indexes relating to potential hazards in a system, a processor programmed to compare the risk hazard indexes with user defined risk criteria to provide an indication of a level of risk for the potential hazards, and an output component for supplying reports generated by the processor. A method for identifying and tracking hazards that is performed using the apparatus is also provided.

### STATEMENT OF GOVERNMENT INTEREST

This invention was made under Contract No. F19628-03-C-0014. The United States Government has rights in this invention under the contract.

### FIELD OF THE INVENTION

This invention relates to methods and apparatus that are used to identify and track hazards.

### BACKGROUND OF THE INVENTION

In the design of complex systems, it is important to protect personnel from accidental death, injury, or occupational illness; to protect systems, equipment, material, and facilities from accidental destruction or damage; and to protect property that might be affected by operation of the systems. Various organizations such as the Department of Defense (DoD) and the Federal Aviation Administration (FAA) have implemented environmental, safety, and health efforts to meet these objectives.

There is a need for a system that can efficiently identify, track and document potential hazards associated with complex systems in accordance with such safety guidelines.

### SUMMARY OF THE INVENTION

In one aspect, the invention provides an apparatus comprising an input component for entering risk hazard indexes relating to potential hazards in a system, a processor programmed to compare the risk hazard indexes with user defined risk criteria to provide an indication of a level of risk for the potential hazards, and an output component for supplying reports generated by the processor.

In another aspect, the invention provides a computer-implemented method for identifying and tracking hazards. The method comprises the steps of: receiving information relating to potential hazards in a system, determining risk criteria for various aspects of the system, assigning a hazard risk index to each of the potential hazards, comparing the hazard risk index with the risk criteria, and producing reports containing results of the comparing step.

### BRIEF DESCRIPTION OF THE DRAWINGS

FIG. 1 is a block diagram of a computer system that can be used to implement the invention.

FIG. 2 is a flow diagram of a closed-loop hazard tracking system in accordance with an embodiment of the invention.

FIG. 3 is a screen display of a user interface.

### DETAILED DESCRIPTION OF THE INVENTION

This invention, referred to as a Hazard Identification & Tracking System (HITS) tool, can be used to identify, track and document potential hazards associated with various systems in accordance with the DoD safety standard MIL-STD-882 and FAA safety guidelines. One objective of the DoD system safety approach is to include mishap risk management consistent with mission requirements in the development of DoD systems, subsystems, equipment, facilities, and their interfaces and operation.

A hazard analysis process is conducted to identify potential hazards associated with components, subsystems, and the integrated system to reduce the overall potential for mishap to an acceptable level of risk. Throughout this process, the ability to accurately document the investigative findings, assess the potential mishap risk, and identify mitigating solutions is critical to the success of any program. Moreover, coordination of hazard analysis data between a staff of System Safety Engineers (SSEs), various companies, and the customer is challenging and requires considerable effort to ensure a high-level of technical accuracy in safety reports that are produced and delivered to the customer.

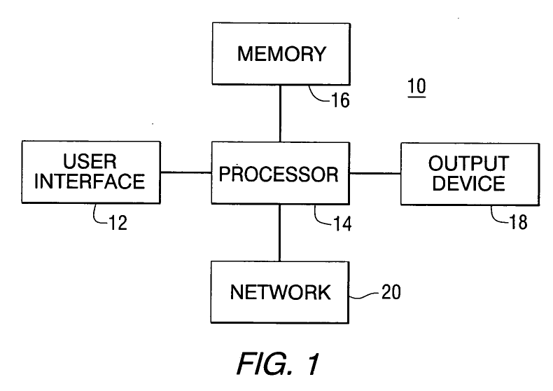

FIG. 1 is a block diagram of a computer system 10 that can be used to implement the invention. The system includes a user interface 12 that is used to input data to a processor 14 that is programmed to perform the functions of this invention. A memory 16 for storing data is accessible by the processor. An output device, such as a display or printer 18 is provided to supply reports generated by the processor. The processor can be operated as a stand-alone device or it can be coupled to a network 20. In some embodiments, multiple users can supply data to the processor and access the output of the processor. HITS can be configured in two ways; as a stand-alone database residing on the user's computer set up as a one-to-one application, or located on a server for multiple users as a many-to-one configuration. This can be accomplished internally using a company Local Area Network (LAN) or externally at remote company sites using a Wide Area Network.

In one embodiment, the Hazard Identification & Tracking System (HITS) tool documents, tracks and characterizes mishap risk of potential hazards associated with complex systems in accordance with the mishap risk guidelines of Department of Defense (DoD) safety standard MIL-STD-882 and Federal Aviation Administration (FAA) Advisory Circular (AC) 25.1309-1A. The HITS tool provides the user with an organized database method for conducting a hazard analysis and assigning applicable levels of mishap risk with the convenience of available drop-down tables, embedded data and memory fields.

As data is entered, the HITS tool assists the user in determining the levels of mishap risk, based on specific parameters selected, by displaying data tables and figures applicable to the risk level selected. The unique attributes of this feature in the HITS is the ability of the user to customize the MIL-STD-882 risk levels within the tables based on specific program requirements defined by the customer. In the MIL-STD-882 application, not all projects are the same in terms of defining an acceptable level of risk. The baseline tables can come directly from MEL-STD-882, but the standard allows for customization based on program requirements. The HITS allows for this flexibility and the responsible Project System Safety Engineer can tailor the HITS data tables to match the requirements imposed on a specific project.

Additional features can include automatic overlay of background color coding of the Hazard Risk Index (HRI) code based on risk level selected from a customizable Hazard Risk Matrix, where the risk level being high, serious, medium, and low can be color coded using, for example, red, yellow, green and blue, respectively. The benefit of this feature is to alert the user of specific risk levels that have been assigned in accordance with their severity. The color coding is useful for drawing attention to those more critical hazards that may require additional safety engineering focus and hazard mitigating solutions.

The HITS tool can be implemented using the Microsoft Access® platform. It provides a closed-loop solution for identifying, tracking and resolving identified hazards. The HITS tool also allows multiple users to input data into individual databases stored on their respective computers or company servers that are used to compile one comprehensive database for a particular program on a program defined schedule, and allows the users to share data based on program needs. The HITS is password protected, which restricts access to those users that are allowed to input data and make modifications. Access is controlled at the program level.

Once the assessment of all hazards is complete, the user selects a report from a list of available reports on a menu and a pre-formatted hazard analysis output report is automatically generated from the data residing in the HITS tool. The output report includes a description of each potential hazard identified, along with all supporting data that was entered into the HITS for each hazard listed, an assessment of the mishap risk with the severity and probability of occurrence clearly shown and annotated as a Hazard Risk Index (HRI), corrective actions necessary to reduce the mishap risk to an acceptable level, and the data used as verification of risk reduction in support of the closure information entered for each item listed, just to name a few.

The output reports from the HITS tool can be in the form of a Portable Document Format (PDF) file which makes the data secure (tamper-proof), portable and easy to read by the recipient. New reports can be added based on user requests during periodic upgrades of the HITS, and the output report data can be formatted to meet almost any request provided the detailed data fields reside in the HITS.

The HITS tool can be used by System Safety Engineers to document potential hazards associated with a system design throughout all phases of a program. It provides a format for a closed-loop hazard analysis solution for identifying, tracking and resolving identified hazards to ensure all hazards identified are shown to be either not credible or mitigated to an acceptable level of risk.

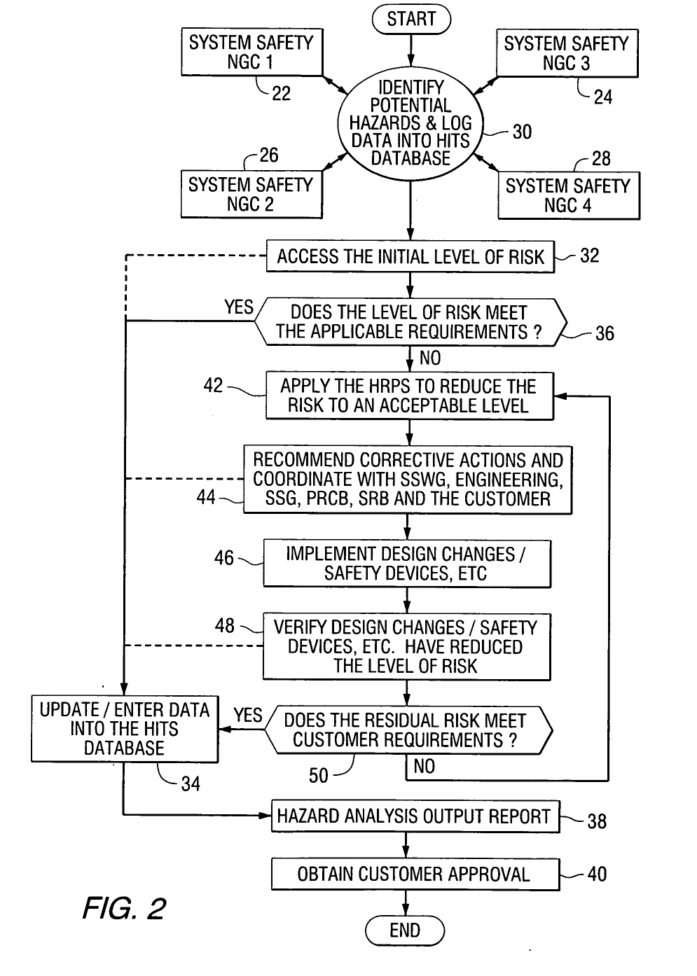

The hazard identification and tracking process is illustrated in the flow diagram of FIG. 2. The process begins by multiple System Safety Engineers (SSEs) 22, 24, 26 and 28 conducting a hazard analysis of a system or device being evaluated to identify potential hazards. The identified hazard data is input into the HITS tool as shown in block 30. The next step for the SSEs is to evaluate the design and assess the initial level of risk using quantitative data from Reliability Engineering or assign a qualitative HRI based on engineering judgment, and then compare the HRI to data in the tables defined by the user in the HITS to determine the applicable risk levels (block 32). This assessment would be defined by the specific program and customer requirements and the HITS tool would be updated by entering the data into HITS accordingly as shown in block 34. Next, the SSEs must determine if the risk is within an acceptable level (block 36).

If the risk is within an acceptable level, then the SSE proceeds to update the potential hazard record data in the HITS tool (block 34) to reflect the most current data and the HITS tool is used to generate the output hazard analysis report (block 38) for delivery to the customer for the customer's approval (block 40).

Otherwise, if the potential hazard is not within an acceptable level of risk, then the next action is for the SSEs to apply the principles of a Hazard Reduction Precedence Sequence (HRPS) to reduce the risk and mitigate the potential hazard to an acceptable level as shown in block 42. This is accomplished by elimination and/or control of the potential hazard to an acceptable level of risk. The application sequence of the HRPS is as follows: (1) Design for minimum hazards by eliminating the hazard; (2) Incorporate safety devices; (3) Provide caution and warning devices; and/or (4) Develop administrative procedural controls and training.

The next step is for the System Safety Engineers to recommend corrective actions to reduce the potential mishap risk and coordinate the recommendations with engineering, management, the customer, and applicable working groups and review boards, as shown in block 44.

The design change would then be implemented by the System Safety Engineer and design team to incorporate the applicable safety devices, include caution and warning devices, and/or identify necessary procedural controls, and training requirements for personnel, as shown in block 46.

Then the SSE must verify that the design changes, safety devices, and other mitigating solutions have been implemented correctly to actually reduce the risk to an acceptable level, and the HITS tool is updated, as shown in block 48. This step can be achieved in several ways, which include inspection, demonstration, test, and/or analysis at both the subsystem and system level. Depending on the type of test necessary, an analysis may be substituted for an actual test where deemed appropriate.

Next, the SSE must again re-evaluate the design, update the corresponding HITS data and assess the level of risk to determine if the application of the appropriate mitigating solutions has, in fact, lowered the residual risk to an acceptable level as defined by the specific program/customer requirements, as shown in block 50. If an acceptable level has been achieved, then the hazard data contained in the HITS tool must be updated by the SSEs (block 34) to reflect the most current data and the mitigating solution, and the process moves forward with the SSEs using the features in the HITS tool to generate the output hazard report data (block 38) for delivery to the customer to obtain formal approval (block 40). If an acceptable level of risk has not been achieved, then additional corrective actions are necessary to reduce the potential mishap risk and the process starts over again until the final residual risk level is acceptable in accordance with program requirements.

The HITS tool can be tailored for a specific application and contains many features that provide the user with an organized method for conducting hazard analyses and for assigning applicable levels of risk. The HITS tool features include structured data entry fields, available drop-down tables for displaying information to the user, embedded data tables for the user to choose from, and memory fields that allow the user to select from a list of previously entered data. As the hazard analysis data is entered, the user determines the level of mishap risk, based on the analysis being conducted, and chooses the specific parameters applicable to each record in the database. The HITS tool can expedite this process by displaying reference data tables applicable to the various risk levels assigned when selected by the user.

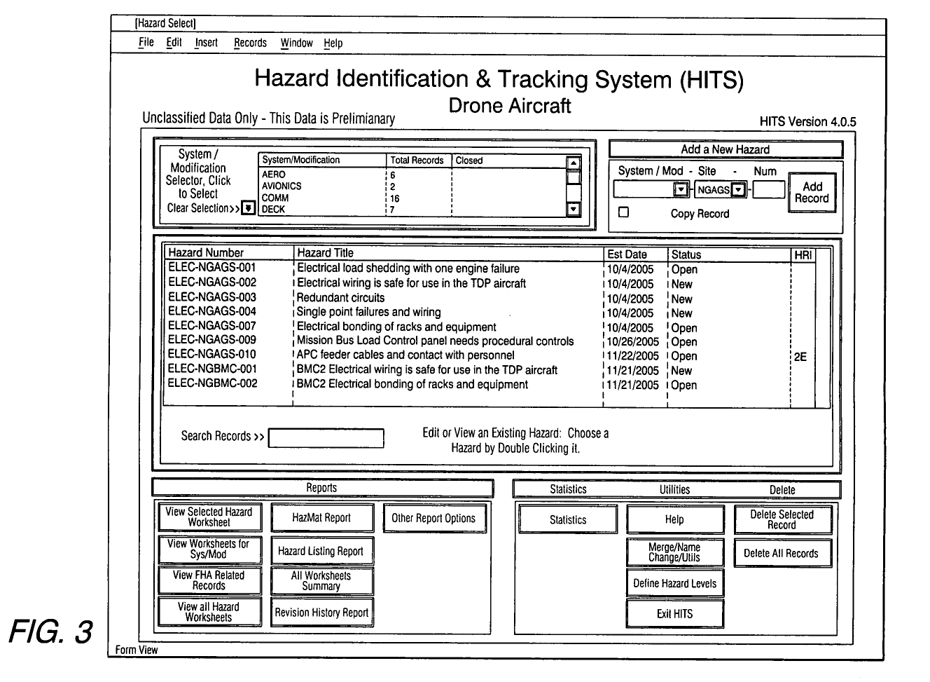

A screen display for the Hazard Identification & Tracking System (HITS tool) is shown in FIG. 3. The screen display includes a viewable listing of subsystems and hazards applicable to the subject project along with all the functions for adding new records, deleting records, generating/printing output reports and various other utilities such as a help menu.

The HITS tool functions on most any computer using Microsoft Access® Runtime or Professional versions. Multiple users can input data into individual HITS tool databases that can later be merged, using a HITS tool merge utility, into one comprehensive database for a specific project. The HITS merge feature allows the user to pull data from up to six individual HITS files into one master file, provided the files are saved in a location accessible by the user. The merge occurs based on a unique site code assigned to each user, this site code allows the merge process to separate user data and pull only data applicable to a specific site (or user).

In addition, it is also possible for a single HITS tool database to be accessed by several users over a Local Area Network (LAN) which makes it easy to share data and have multiple System Safety Engineers working on the same project simultaneously provided they all have unique site names. Since the HITS tool is a database file, it is portable and can be moved or copied from one computer to another or to removable media such as a thumbdrive or diskette.

The HITS tool allows System Safety Engineers (SSEs) to input hazard analysis data on components, subsystems and systems as they relate to the safety of airborne, sea-based, or land-based platforms. It contains many features that provide the user with an organized method for conducting a hazard analysis and for assigning applicable levels of mishap risk in accordance with the methodology in the tailored guidelines of MIL-STD-882 and the requirements of Federal Aviation Administration (FAA) Advisory Circular (AC) 25.1309-1A.

The HITS tool is used in the process of identifying hazards during the design and development of components, subsystems and systems. It provides automated documentation as the output product delivered to the customer. The HITS tool can be implemented as a stand-alone application that resides on the user's computer (not a central server) and the data can be manually entered by each SSE and is stored at each desktop/laptop location.

Prior to the HITS tool being developed, it would normally take hundreds, and sometimes thousands of man-hours to generate formal hazard analysis reports. Now a formal report can be generated in just a few seconds and can be up to hundreds of pages in length.

While the invention has been described in terms of several embodiments, it will be apparent to those skilled in the art that various changes can be made to the described embodiments without departing from the scope of the invention as set forth in the following claims.

What is claimed is:

1. An apparatus comprising:
an input component for entering risk hazard indexes relating to potential hazards in a system;
a processor programmed to compare the risk hazard indexes with user defined risk criteria to provide an indication of a level of risk for the potential hazards; and
an output component for supplying reports generated by the processor.

2. The apparatus of claim 1, further comprising:
a memory including tables of data of the user defined risk criteria.

3. The apparatus of claim 1, wherein the reports include color coded information based on risk level.

4. The apparatus of claim 1, wherein the reports include an assessment of mishap risk and corrective action.

5. The apparatus of claim 1, wherein the reports include:
a description of each potential hazard identified, supporting data, an assessment of the risk, a description of corrective actions necessary to reduce the risk to an acceptable level, and closure information for each potential hazard identified.

6. A computer-implemented method for identifying and tracking hazards, comprising the steps of:
receiving information relating to potential hazards in a system;
determining risk criteria for various aspects of the system;
assigning a hazard risk index to each of the potential hazards;
comparing the hazard risk index with the risk criteria; and
producing reports containing results of the comparing step.

7. The method of claim 6, further comprising the steps of:
determining if the hazard risk index is below an acceptable level; and
if the hazard risk index is not below an acceptable level, implementing a hazard reduction procedure.

8. The method of claim 7, further comprising the step of:
re-evaluating the potential hazards following the hazard reduction procedure.

9. The method of claim 6, further comprising the step of:
updating the risk criteria.

10. The method of claim 6, wherein the risk criteria comprises tables of data.

11. The method of claim 6, wherein the reports include:
a description of each potential hazard identified, supporting data, an assessment of the risk, a description of corrective actions necessary to reduce the risk to an acceptable level, and closure information for each potential hazard identified.
